(19) United States
(12) Patent Application Publication
(10) Pub. No.: US 2016/0155322 A1
(43) Pub. Date: Jun. 2, 2016

(54) RADIO CONTROL SYSTEM FOR CONTROLLING AT LEAST ONE MACHINE, IN PARTICULAR A CRANE

(71) Applicants: Wolfgang BRENDEL, Crailsheim (DE); Friederike BRENDEL, Crailsheim (DE)

(72) Inventors: Wolfgang BRENDEL, Crailsheim (DE); Friederike BRENDEL, Crailsheim (DE)

(21) Appl. No.: 14/900,769

(22) PCT Filed: May 16, 2014
(86) PCT No.: PCT/EP2014/060092

§ 371 Date: Dec. 22, 2015

(30) Foreign Application Priority Data
Jun. 25, 2013 (DE) 10 2013 212 071.0

(51) Int. Cl. G08C 17/02

(52) U.S. Cl. CPC G08C 17/02; G08C 2201/20

(57) ABSTRACT

The invention relates to a radio control system for machine control, comprising:
a radio receiver (7) on the machine, to which receiver a unique identification mark is assigned,
a mobile data medium (9) which is assigned to the radio receiver (7) but can be transported separately therefrom, and contains the information regarding the identification mark of the radio receiver (7) as input data,
a radio transmitter (1) for generating and transmitting radiograms to the radio receiver (7), wherein a unique identification mark is also assigned to the radio transmitter (1), wherein the radio transmitter (1) comprises an interface for transmitting data, to which interface the mobile data medium (9) can be connected for data transmission and by means of which information regarding the identification mark of the radio receiver (7) can be transmitted from the mobile data medium (9) to the radio transmitter (1),
   wherein the radio transmitter (1) is also designed to generate and store identification data on the basis of this information regarding the identification mark of the radio receiver (7), and wherein the radio transmitter (1) is also designed to include the identification data in its radiograms, wherein
   the radio receiver (7) can be initialised such that it accepts radiograms for the machine control if they contain relevant identification data in the radiograms.

The invention relates to a radio control system for controlling at least one machine, in particular a crane, comprising a radio receiver on the machine, to which receiver a unique identification mark is assigned, and a radio transmitter for generating and transmitting radiograms containing control commands to the radio receiver, a unique identification mark also being assigned to the radio transmitter. The identification marks can for example be device numbers or device addresses that are stored in the devices.

Radio control systems of the type in question here typically comprise a radio receiver installed on the machine to be controlled and a radio transmitter which is normally mobile, i.e. can be carried by an operator, for wirelessly transmitting control commands to the radio receiver.

Within the context of the present invention, the term ‘radio transmitter’ is not only intended to include the simple radio transmission part, but also a wider device in particular comprising operating elements that can be operated by an operator to specify control commands, and electronic circuits, including microcomputer circuits or controller circuits, for internal control and for carrying out device functions, e.g. generating and transmitting radiograms. The radio transmitter can comprise additional components and functions. Likewise, the term ‘radio receiver’ should not only be understood to be a simple radio receiver part, but also a device which, in addition to radio receiver components, comprises electronic circuits, including microcomputer circuits or controller circuits, for internal control and for carrying out device functions, e.g. for checking and converting received radio control data into machine control command signals, the receiver being integrated in a control system on the machine, which system implements the control commands provided by the radio receiver, e.g. to control actuators or machine switching apparatuses.

Cranes, lifting equipment and other conveyor systems, adjusting systems, construction machines and the like are possible examples of radio controllable machines.

One of the main objectives in radio control technology is to securely actuate the crane or the machine over the air interface.

For security reasons, the radio transmitter and the radio receiver of a radio control system have to be uniquely assigned to one another at all times throughout the radio control operation. It has to be ensured that a plurality of radio transmitters cannot have access to the radio receiver in an uncontrolled or uncoordinated way and that, as a result of such a situation, control is maintained over the operation of the machine to be controlled. To ensure reliable radio control of machines, up to now the radio transmitter and the radio receiver installed on the machine have been uniquely assigned to one another by an exclusively administered address code in the communication protocols (radiograms). This ensures that, for the machine control, the receiver only accepts correspondingly encoded radiograms or radiograms provided with relevant address information from the transmitter assigned thereto. Up to now, the address specifications have typically been produced within the associated devices by storing the relevant address data (identification marks) in read-only memories of the transmitter and receiver. Programming of this type in a read-only memory normally takes place at the factory during the production process of the radio transmitter and radio receiver, it being possible for the read-only memories used to be exchangeable modules which can be swapped as needed only by specially qualified and authorised personnel. On the transmitter, it is also known that such a module programmed with a unique address can also have key functions and as such can be removed from the transmitter to block access to the transmitter.

It is also known to store the unique assignment addresses of a radio transmitter-radio receiver pair in a modifiable manner by making use of circuit components such as DIP switches, although these circuit components are accommodated securely within the device housing and their address memory switching states should only be changed as needed by specially qualified and authorised personnel. Until now, therefore, a radio transmitter and a radio receiver have typically been uniquely “paired” by presetting, at the factory prior to the device being shipped, the assignment addresses that are to be used in the communication protocols, since the exchangeable address memory modules for the system are in particular also provided in unique pairs ex works.

Experience has shown that a very high percentage of all the malfunctions of radio control systems of the type being discussed here are down to defective radio transmitters. If a radio transmitter fails, whether due to a defect or a loss, it is therefore desirable for a replacement transmitter to be provided in a simple manner and to be activated while maintaining a high level of security so that the replacement transmitter can substitute the defective or lost radio transmitter, even with regard to the unique assignment of a relevant radio receiver.

In the case of the address memory module needed as a key, this module remains on the transmitter during operation and is generally not removed. Therefore, in principle it cannot be assumed that the key is still available if the transmitter is lost. The problem of the replacement transmitter is thus not solved. Until now, it has not been possible to put a replacement transmitter into operation with an identical module by using exchangeable and fundamentally duplicable address memory modules. However, if a transmitter which was believed to have been lost together with the earlier address memory module happens to reappear, the duplication of the key poses a security risk. It would be desirable to have a system which can forget replaced or removed components and always reject them as being invalid once they have been removed.

A second essential task in radio control technology is a flexible system setup made up of one or more transmitters and one or more receivers for actuating one or more machines. In principle, radio technology has many significant advantages over wired control technology. Until now, a system configuration consisting of one or more transmitters and one or more receivers has been generally set prior to the system being shipped. This configuration is thus fixed and cannot be subsequently modified. It would be desirable to have a system that can also be reasonably expanded or supplemented at a later date.

DE 10 2006 012 471 B4 discloses a system for wirelessly transmitting control commands for controlling lifting equipment, in particular a crane, wherein a wireless operating part, which comprises a radio transmitter, has a distinctive address and a receiving part of the lifting equipment has a selectable identifier. A unique assignment of the operating part to the receiving part has to be created in that an address feature is formed from the address of the operating part and the identifier of the receiving part, and this address feature is emitted from the operating part and received by the receiving part in an allocation message, the operating part then being allocated to the receiving part. Future control commands can then be wirelessly transmitted by the operating part to the receiver. The identifier linked with the address of the operating part to form an address feature can for example be a machine number which is arranged in an easily visible location on the lifting equipment and which the operator has to input into the operating part, e.g. by keyboard input, during an initialisation routine. This known system forms a flexible assignment of the operating part to the receiving part. However, it does not hold up to the highest security requirements. For example, if an unauthorised person is in possession of the operating part, he can potentially perform an allocation between the operating part and the receiving part on the lifting equipment and establish a working radio control connection.

The object of the invention is to provide a radio control system of the type mentioned at the outset which allows the user to create a flexible and possibly modifiable assignment between at least one radio transmitter and at least one radio receiver while maintaining high levels of security for the radio control operation.

To achieve this object, a radio control system having the features of claim 1 is proposed, specifically a radio control system for controlling machines, in particular cranes, comprising the following features:
a radio receiver on the machine, which is assigned its own unique identification mark,
a mobile data medium which is assigned to the radio receiver but can be transported separately therefrom and contains the information regarding the identification mark of the radio receiver as input data,
a radio transmitter for generating and transmitting radiograms to the radio receiver, wherein the radio transmitter likewise comprises its own unique identification mark and further comprises an interface for inputting data, to which interface the mobile data medium can be connected for data transmission and by means of which information regarding the identification mark of the radio receiver can be transmitted from the mobile data medium to the radio transmitter, wherein the radio transmitter is also designed to generate and store identification data on the basis of this information regarding the identification mark of the radio receiver by executing appropriate programs and applying appropriate algorithms, and wherein the radio transmitter is also designed to include the identification data in its radiograms, wherein the radio receiver can be initialised such that it accepts radiograms for the machine control if they contain relevant identification data in the radiograms, the radio transmitter being designed to generate the identification data not only on the basis of information regarding the identification mark of the radio receiver, but also on the basis of the identification mark of the radio transmitter.

The identification mark of the radio receiver is preferably a set, specific receiver address or device number that is permanently stored in the receiver. Similarly, the identification mark of the radio transmitter is likewise a set, specific radio transmitter address or device number that is permanently stored in the radio transmitter.

According to the present invention, however, the identification marks of the radio receiver and the radio transmitter do not have to already be coordinated with one another at the factory, i.e. they can also be, and normally are, completely different. There is no need for a preset assignment (pairing) of the radio transmitter and radio receiver at the factory since an assignment of this type can be carried out by a user in a simple manner and with little effort during an initialisation process when the radio control system is first put into operation. In the process, the identification mark of the radio receiver is to be communicated to the radio transmitter by data transmission via its data transmission interface. This is carried out by reading out the mobile data medium containing the identification mark of the radio receiver. Depending on the type of mobile data medium, a data reading process of this type can take place in a contactless manner, for example by using RFID or radio technology, or by means of electrical contact connections of the mobile data medium and the radio transmitter, optionally with connection lines connected therebetween. According to a particularly preferred variant of the invention, the identification mark of the radio receiver is stored on a chip card which can be read and optionally written to in a contactless manner by a corresponding reading and optionally writing apparatus in the transmitter or optionally also in the receiver, and which can be connected to the radio transmitter for data transmission for the initialisation process as a mobile data medium. Other cards, e.g. magnetic strip cards, are also possible. For this purpose, the radio transmitter comprises a suitable reading and optionally writing device assigned to the data transmission interface. The radio transmitter can store the information input by the mobile data medium regarding the identification mark of the radio receiver. The mobile data medium is a separate authorisation badge, without which a functional assignment of the radio transmitter to the radio receiver would not be possible at all. It is thus not sufficient to only have the radio transmitter and know the identification mark of the radio receiver to establish a working radio control connection. The process of inputting the information from the mobile data medium to the radio transmitter is also a part of this. Once the radio transmitter has been assigned to the radio receiver, the mobile data medium can be stored away, e.g. in a safe, until it is needed for a potential new initialisation operation.

Apart from the identification mark of the radio receiver, the mobile data medium preferably also contains as stored data additional radio system information, such as data regarding system configurations that are currently configured and/or allowable in principle, it being possible for such additional system information to be taken into account during initialisation processes.

Depending on the information input by the mobile data medium regarding the identification mark of the radio receiver, the radio transmitter can generate and store identification data by applying appropriate algorithms, which identification data enable a desired, defined assignment between the radio transmitter and the radio receiver, information regarding the permitted assignments preferably being stored on the mobile data medium. According to a preferred variant of the invention, the radio transmitter and the radio receiver are designed to generate and to bilaterally adopt this identification data to form a common system address during the initialisation process. During the initialisation process, the radio transmitter transmits this system address it has generated to the radio receiver, preferably by radio. Said receiver recognises the transmitter contacting it in that the transmitter transmits identification data by which the receiver is uniquely addressed, the receiver learning the identity of the transmitter and being able to accept said transmitter as its radio partner. Therefore, for the first time during initialisation and thus during normal operation, the radio transmitter has to include the identification data (system address) in its radiograms. Radiograms generated in this way and transmitted to the radio receiver are then accepted by the radio receiver as permissible data for the machine control. Foreign radiograms that do not correspond to the communication protocols defined during the initialisation between the radio transmitter and radio receiver, i.e. do not contain the identification data (common system address) of the radio transmitter and the radio receiver, are not accepted by the radio receiver for the machine control.

According to an embodiment of the invention, the information regarding the identification mark of the radio receiver, which information is read by the mobile data medium and stored by the radio transmitter, is written onto one or more additional mobile data media by the radio transmitter, and so copies or partial copies of the original mobile data medium can be produced.

During the initialisation process for putting the radio control system into operation, a common system address can be generated for the radio receiver and for the radio transmitter, which address is based on the identification marks of the two devices and therefore information, which can be interpreted by the receiver, regarding the specific transmitter is contained in the relevant radiograms of the transmitter. Owing to a specific transmitter ID of this type in the radiograms, a radio transmitter which has up to then been accepted by the receiver as a radio partner can for example be ruled out as a partner for the future if, for example, it has been replaced by a replacement transmitter and a corresponding initialisation process has taken place for said replacement transmitter. A lost transmitter can thus be excluded from the radio system, and so radiograms sent by said transmitter after it is possibly found again are no longer accepted by the radio receiver as instructions for the machine control.

According to a preferred development of the invention, the radio control system comprises at least one mobile badge data medium which is to be assigned or is assigned to the radio transmitter as an authorisation of use badge and can be transported separately therefrom, and in which authorisation of use data are or can be stored and which can be connected to the radio transmitter for data transmission, the radio transmitter being designed to exchange data with the badge data medium that has been connected thereto for data transmission, to check authorisation of use data from the badge data medium, and, if the result of the check is positive, to allow the transmission operation thereof for radio controlling the relevant machine, and so the radio transmitter can be enabled for the transmission operation by means of the badge data medium.

According to an embodiment of the invention, the radio transmitter can be operated in an initialisation mode in which, once the common data transmission connection has been established, said transmitter can read, from the badge data medium, an identification mark assigned thereto and store this identification mark. In the simplest example, this identification mark corresponds to the authorisation of use data from this time onwards.

Preferably and according to another embodiment of the invention, the radio transmitter can be operated in an initialisation mode in which said transmitter can input the authorisation of use data into the badge data medium which has been connected thereto for data transmission. To generate the authorisation of use data, the radio transmitter can be designed to read, from the badge data medium, an identification mark assigned thereto and to form a dataset preferably on the basis of both the identification mark of the badge data medium and the identification mark of the radio transmitter, and to store this dataset in the badge data medium, this dataset corresponding to the authorisation of use data. Following such an initialisation operation, the badge data medium can be used as a key to enable the radio transmission operation of the radio transmitter. Preferably, the radio system according to the invention is designed such that the badge data medium does not have to remain on the radio transmitter following enabling, but rather can for example be stored away by the operator until the next enabling.

The badge data medium is preferably a data medium that can be read and optionally written to in a contactless manner (e.g. RFID modules or RFID chip cards), wherein, to be adapted to do so, the radio transmitter should comprise a suitable reading and optionally writing device, by means of which a connection to the data transmission interface of the radio transmitter can be produced for the badge data medium. In this case, the data transmission interface of the radio transmitter can be an RFID interface. In the context of the invention, other cards are also generally possible as mobile data media, e.g. magnetic strip cards, which in turn can be read and optionally written to by a suitable reading and optionally writing device, or active memory chips.

The radio system according to the invention can comprise a plurality of such badge data media in order to allow different people to be authorised to use the radio transmitter, wherein each of these badge data media is to be initialised by means of the radio transmitter in the aforementioned way before it can function as a key. If there is a plurality of such badge data media, they can be allocated different authorisation of use data within the meaning of differently matched sub-addresses. For the radio transmitter, a distinction can be drawn between the various badge data media so that it can optionally be logged which specific badge data medium was used for the radio control at which time. However, it is also possible to prepare the badge data medium or some of the badge data media to be identical to the authorisation of use data so that they are indistinguishable as keys. Logged data can be stored in the radio transmitter and/or optionally on a badge data medium in a write-back operation.

According to a variant of the invention, it is additionally possible to also use the badge data media of different people in systems which are separate from the radio control system and require enabling or a login by a key of this type, for example as an authorisation for access to work areas, it being possible by means of such a key to in turn collect user data, e.g. for time recording purposes.

Following complete and successful initialisation of the system, i.e. the initialisation operation between the badge data medium and radio transmitter and the initialisation process between the radio transmitter and radio receiver, the normal radio control operation can be carried out. An operator can specify control commands on appropriate operating elements of the radio transmitter. In the case of controlling a crane, for example a jib crane, for example control commands for adjusting the angle of rotation of the crane, for lifting or lowering the crane hook, or for moving the trolley of the crane can be specified, as is known from the prior art.

The radio control system according to the invention can comprise a plurality of badge data media, to which authorisation of use data are to be allocated in the aforementioned way in a relevant initialisation mode, it being possible for these authorisation data to be different and to contain information regarding limited (or expanded) authorisations of use which can be interpreted by the radio transmitter and implemented by the radio control system for limiting (or optionally expanding) the machine control to certain modes of operation of the machine(s) to be controlled depending on the extent of the authorisation of use.

By selectively distributing the badge data media to differently qualified operators, it can thus be ensured that some modes of operation of the machine that require particular attention and qualifications from the operator for the control can only be used by operators with the corresponding qualifications.

Up to now, clear reference has not yet been made to the fact that the radio system according to the invention is not only limited to a single radio transmitter and a single radio receiver, but rather can be expanded as required. For example, it is entirely possible to have configurations in which one radio transmitter can communicate with a plurality of radio receivers or a plurality of transmitters can communicate with one receiver or a plurality of transmitters can communicate with a plurality of receivers. In the possibility described above of the combination of one radio transmitter and one radio receiver to form a radio control system according to the invention, a “point-to-point” operation is possible, for example in the case of crane control, wherein the radio receiver installed on the crane only accepts radio control commands in the form of datagrams which originate from the one radio transmitter and contain the relevant identification data, optionally in encrypted form.

When the radio control system is configured with one transmitter and a plurality of receivers installed in various adjacent cranes, “tandem operation” of the cranes is possible. In this case, for example two cranes can hold a common load and move synchronously, the operator being able to specify the movement commands by means of the one radio transmitter.

When the radio control system is configured with a plurality of transmitters and a single receiver, e.g. when controlling a crane, the “catch-release mode” is possible, in which an operator can for example control the load bearing of the crane and part of the subsequent load movement by means of a first transmitter and another operator can use a second transmitter to control the further movement of the load and optionally the placement of the load. A mode of operation of this type can be advantageous if the load is to be lifted over unclear terrain.

Other operation options are produced when the radio control system is configured with a plurality of transmitters and a plurality of receivers.

When the radio control system is configured with a plurality of transmitters and a plurality of receivers, an operation mode in which the first transmitter being put into operation selects a particular receiver and thus takes control of the associated crane (the associated machine) is also possible. Until it is actively enabled by this precise transmitter, this crane (this machine) then remains blocked for all other transmitters being put into operation (“first-come-first-serve” principle).

Within the context described above, the radio control system according to a development of the invention comprises a plurality of radio receivers, each of which has a unique identification mark, and each radio receiver being assigned its own yet separately transportable mobile data medium containing stored information regarding the identification mark of the relevant radio receiver, it being possible to connect the relevant mobile data medium to the radio transmitter for data transmission in order to transmit the information regarding the identification mark of the relevant radio receiver to the radio transmitter, and the radio transmitter being designed to generate and store identification data, which are to be assigned to the relevant radio receiver, on the basis of this information regarding the identification mark of said receiver, and the radio transmitter also being designed to include the identification data in its radiograms for the particular radio receiver, it being possible to initialise each radio receiver such that it only accepts radiograms for the machine control when they contain identification data assigned to said receiver in the radiograms.

According to another embodiment of the invention, the radio transmitter comprises a plurality of radio transmitters, each of which has an interface for inputting data, by means of which information regarding the identification mark of a particular radio receiver can be input into the relevant radio transmitter, and each radio transmitter also being designed to generate and store identification data, which are assigned to the relevant radio receiver, on the basis of this information regarding the identification mark of said receiver, and each radio transmitter also being designed to include the identification data in its radiograms, it being possible to initialise each radio receiver such that it only accepts radiograms it has received for the machine control when they contain identification data assigned to said receiver in the radiograms.

The system configuration (point-to-point, tandem operation, catch-release, first-come-first-serve) selected during the set-up of the radio system consisting of one or more transmitters and one or more receivers can be changed at any later point by rerunning the initialisation process.

Preferably, for each of the radio transmitters there is at least one separately transportable mobile badge data medium which is assigned or is to be assigned to the particular radio transmitter as an authorisation of use badge and in which authorisation of use data are or can be stored and which can be connected to the particular radio transmitter for data transmission, each radio transmitter being designed to exchange data with the badge data medium which has been connected thereto for data transmission, to check authorisation of use data from the badge data medium, and, if the result of the check is positive, to approve its transmission operation for radio controlling the machine and so the radio transmitters can be enabled for the transmission operation by means of the badge data medium.

Preferably, each of the radio transmitters can be operated in an initialisation mode in which said transmitter can input the relevant authorisation of use data into the badge data medium that has been connected thereto for data transmission.

According to a development of the invention, some of the badge data media can contain authorisation information which is assigned to particular modes of operation of the machine(s) to be controlled, the radio transmitters, when activated for the transmission operation by such a badge data medium, being able to transmit the authorisation information, or data derived therefrom, in their radiograms, and the radio receivers, upon receipt of such radiograms, being designed to allow only certain modes of operation of the machine(s) in the machine control, depending on the authorisation information or data derived therefrom.

The radio transmitters are preferably designed to pick up and log user data and/or data regarding their particular transmission operation, and preferably to store at least some of this data in the particular badge data medium by which it has just been enabled for the transmission operation. The receiver can also write data to the mobile data medium assigned thereto, for example operation data and/or user data.

The above explanations show that the radio control system according to the invention can be initialised and modified, i.e. also configured in terms of the system configuration, by the user in a flexible, simple and reproducible manner while maintaining a high level of security, and furthermore allows various configurations of radio transmitters and radio receivers.

A further interesting aspect of the invention relates to a radio control system for controlling machines, comprising at least one radio receiver per machine, at least one radio transmitter for generating and transmitting radiograms to at least one of the radio receivers in each case, and a group of mobile data media which are or can be selectively assigned to the radio receivers and can contain or accept addressing information for the selective addressing of individual radio receivers by the radio transmitter, the radio transmitter having an interface for data transmission and each of the mobile data media being able to be connected for data transmission to the radio transmitter via the interface thereof in order to transmit the relevant addressing information to the radio transmitter, the radio transmitter also being designed to generate, on the basis of the addressing information it has received from a particular mobile data medium, specific identification data for addressing the radio receiver to which the relevant mobile data medium is assigned, and the radio transmitter also being designed to include the specific identification data in its radiograms, and so these radiograms are only accepted for the machine control by the radio receiver for the addressing of which the specific identification data was generated by the radio transmitter in each case.

The mobile data media are preferably chip cards, particularly preferably RFID chip cards, the data transmission interface of the radio receiver being adapted according to the type of chip card, i.e. it is preferably an RFID interface.

The radio control system mentioned according to this further aspect of the invention can be integrated in the above-described radio control system according to the invention, it being possible for example for the mobile data media to be badge data media according to claim 5.

The radio control system according to the further aspect of the invention allows for a particular machine (or optionally a particular subassembly) to be selected in each case from a group of machines in order for said machine to be controlled by the radio transmitter. The machines that can be controlled by the radio control system can for example be stationary machines, but can in particular be mobile machines, such as ground vehicles, watercrafts or aircrafts or components of such vehicles, thus for example trailers for transporting material to be transported, it being possible for a trailer, which is to be moved at that moment, to be controlled in each case by means of the radio transmitter from a central monitoring station. In this example, the trailer that can be controlled in each case is the one to whose radio receiver the mobile data medium that is being used at that time for activating the radio transmitter belongs, according to the assignment. If the trailer being controlled at that time has dealt with its present transport task, the radio transmitter can be reprogrammed by initialisation by means of another mobile data medium so that is can address another receiver with its radiograms in order to be able to control the machine associated therewith, for example another particular trailer from the trailer group in question. Preferably, the radio transmitter is designed or programmed such that it has to be reinitialised by means of a mobile data medium after each time the control operation is disabled. This prevents an operator from accidentally activating a machine that was previously an addressee of the radio control by means of the radio control system, e.g. by another operator. A plurality of radio transmitters which can be initialised by means of the individual mobile data media in order to control selected machines can also optionally be included in the radio control system.

A possible initialisation process for the first set-up of the radio control system and various modes of operation will be described below on the basis of radio control of cranes with reference to the figures, in which:

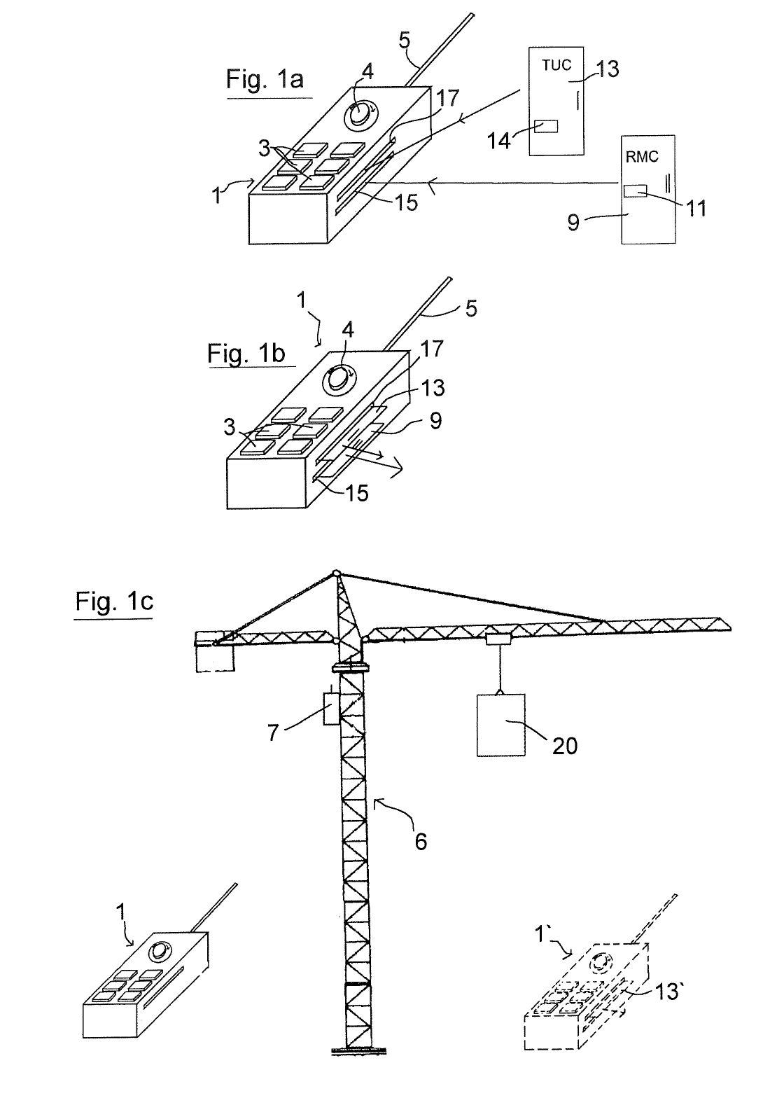

FIG. 1a to 1c are schematic views of an embodiment of a radio control system according to the invention in various stages of the first set-up thereof.

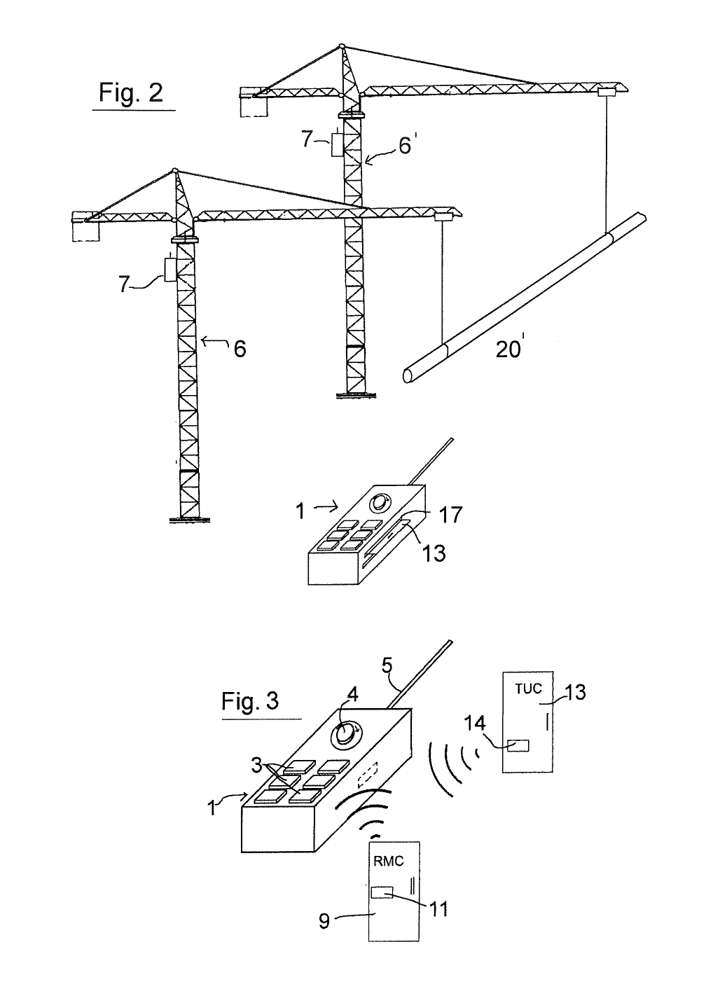

FIG. 2 is a schematic view of a moment in time of a tandem operation of two jib cranes comprising a radio control system according to the invention.

FIG. 3 is a schematic view of a radio transmitter and two mobile data media, which can wirelessly exchange information via RFID data transmission.

The radio transmitter 1 in FIG. 1a to 1c comprises buttons 3 and a rotary knob 4 as operating elements. The operating elements 3, 4 can be operated to specify machine control commands which are to be transmitted by the radio transmitter 1 in radiograms for controlling a machine, for example for controlling a jib crane 6. The type and number of operating elements can vary in various radio transmitters of a radio system according to the invention. The radio transmitter 1 has an integrated transmission part having a radio transmission antenna 5 and an internal circuit arrangement having a microcomputer circuit for picking up data and for organising and controlling the radio transmission functions. A radio receiver 7, which for example is installed on the machine on the jib crane 6 of which the operating functions are to be controlled by means of the radio control system, is also part of the radio control system according to the invention.

Before the radio control system is put into operation for the first time, the radio transmitter 1 and the radio receiver 7 are not yet assigned to one another. This is carried out by means of an initialisation method according to the invention. The radio control system comprises an RMC chip card 9 (receiver master card) as a mobile data medium, which comprises a memory chip 11 on which a unique identification mark of the radio receiver 7 is stored. This RMC chip card 9 is assigned specifically and exclusively to the radio receiver 7 and is typically supplied by the manufacturer with the receiver 7.

The radio control system according to the invention also comprises at least one TUC chip card 13 (transmitter user card) which is used as a key for enabling the transmission operation of the radio transmitter 1 and for example receives corresponding authorisation of use data during the initialisation process.

The RMC chip card 9 is to be inserted into the card insertion slot 15 in the radio transmitter 1 in order to produce a data-transmission contact between the memory chip 11 of the RMC chip card 9 and a data transmission interface of the radio transmitter 1. Similarly, the TUC chip card 13 is to be inserted into the card insertion slot 17 in the radio transmitter 1 in order to connect, for data transmission, the memory chip 14 of the TUC chip card 13 to a relevant data transmission interface of the radio transmitter 1 (cf. FIG. 1a).

If this is successful or unsuccessful, the readout of the TUC data (as well as possible writing to the TUC chip card 13) is displayed by suitable optical, acoustic or haptic feedback and can optionally be acknowledged by operating an operating element.

FIG. 1b shows the radio transmitter 1 having inserted chip cards 9, 13. In this state, a first initialisation routine of the radio transmitter 1 can be launched. In this initialisation routine, the radio transmitter 1 reads the identification mark of the radio receiver 7 from the memory chip 11 of the RMC chip card 9, and forms a dataset on the basis of the identification mark of the radio receiver 7 and the identification mark of the radio transmitter 1, which dataset forms a common system address for the radio transmitter 1 and for the radio receiver 7. The radio transmitter 1 stores this system address for future radio operation and also transmits it to the radio receiver 7, which is designed to recognise the system addresses, which is determined according to a predetermined algorithm including its identification mark, as being such a system address, and to store said address for future adjustment operations when radiograms are received. Furthermore, during the initialisation process, the TUC chip card 13 can also be activated by the radio transmitter 1 reading an identification mark of the TUC chip card 13 from the memory chip 14 thereof, forming an authorisation of use dataset on the basis of this identification mark and the identification mark of the radio transmitter 1, and storing said dataset in the memory chip 14 of the TUC chip card 13. Following these initialisation operations, the radio transmitter 1 can transmit radiograms containing machine control instructions to the radio receiver 7, the radio transmitter 7 recognising and accepting the radiograms on the basis of the system address data that are included in the radiograms in a preferably encrypted manner.

The RMC chip card 9 is no longer required for the further normal operation of the radio control system for the machine control (in this case, the crane control), and can be stored away in a secure location to keep it ready for further initialisation operations if for example a replacement radio transmitter or optionally an additional radio transmitter is intended to be integrated in the radio control system.

For the radio transmission operation of the radio transmitter 1 for the machine control, it is necessary for a valid TUC chip card 13, i.e. a chip card that has been properly initialised by the radio transmitter, to be inserted in one of the card slots 15, 17, or to have been used briefly for enabling and to thus be logged into the radio transmitter. The TUC chip card 13 thus forms a key for enabling the radio transmission operation of the radio transmitter 1. The TUC chip card 13 does not have to remain on the radio transmitter following enabling, but instead can be stored away in another location (e.g. carried by the operator). According to a variant of the invention, during an enabling process the transmitter 1 only emerges from a preparatory state and becomes ready for radio operation when the TUC card has also been removed from the slot 15 or 17. In this context, the radio transmitter 1 is shown in FIG. 1c in the operation-ready state and can be operated by an operator to specify control commands for the crane 6 by means of the operating elements 3, 4, wherein the control commands are to be sent to the receiver 7 as radiograms.

The radio receiver 7 is involved in the on-site control system of the crane 6 in a manner known per se, and generates, according to the received radiograms, control signals for drives and the like of the components of the crane 6 that are to be controlled.

In dashed lines, FIG. 1c shows an additional radio transmitter 1′, which has already been initialised according to the radio transmitter 1 in the above-described manner, and can likewise transmit datagrams to the radio receiver 7. The radio transmitter 1′ is enabled by an accordingly validated TUC chip card 13′. A configuration of this type of the radio control system consisting of at least two radio transmitters 1, 1′ and one radio receiver 7 on the machine allows certain modes of operation of the radio control system and of the crane 6, provided said system is configured for the relevant modes of operation, e.g. for catch-release operation of the crane 6 for transporting a load over unclear terrain. In this case, the crane is first controlled in accordance with control commands from the first radio transmitter 1, for example to collect the load 20 at a location that is easily visible to an operator having the first radio transmitter 1. Next, the control over the radio control system can be passed to the second radio transmitter 1′, which for example is operated by another operator who, unlike the first operator, has a good view of the location at which the load is to be placed. It can be provided for only specially authorised operators to be allowed to use special modes of operation of this type, such as the catch-release operation. Within the scope of the present invention, in such a case the TUC chip cards 13, 13′ entrusted to the relevant operators contain corresponding authorisation endorsements in their authorisation of use datasets, the radio transmitters 1, 1′ interpreting the authorisation endorsements received by a particular TUC chip card 13′, 13 which contains the authorisation of use dataset and being able to convert them into corresponding control commands that are required for enabling or running a relevant special mode of operation and are to be transmitted to the radio receiver in radiograms.

FIG. 2 illustrates another special mode of operation, specifically tandem operation using two cranes 6, 6′ which carry the same load 20′ and are intended to carry out synchronised transport movements. In the example according to FIG. 2, the radio control system comprises two radio receivers 7 and a radio transmitter 1. The radio transmitter 1 has been initialised by means of the RMC chip cards 9 of the two receivers 7 such that it can address the two radio receivers 7 with its radiograms. In its authorisation of use dataset, the TUC chip card 13 comprises authorisation endorsements as a prerequisite for enabling or running the tandem operation of the cranes 6, 6′.

In general, it should be noted that, in the case described at the outset as being problematic, in which a radio transmitter is lost, a replacement transmitter is paired with the original receiver 7 by running the initialisation routine. For this purpose, it is necessary to use both the RMC chip card 9 belonging to the radio receiver 7 and all the TUC chip cards 13 identifying all the operators. After the replacement transmitter has been re-paired and started, the original radio transmitter will no longer be accepted by the radio receiver 7 as a radio partner. If a radio transmitter that was believed to have been lost reappears, this does not pose a security risk. If the found radio transmitter is intact, it can in turn be kept as a replacement transmitter or be used in a second radio system, it then being possible for said transmitter to be paired with a second receiver.

FIG. 1a-1c show the radio transmitters 1 having card insertion slots for receiving the TUC chip card 13 and the RMC chip card 9, wherein the chip cards 9, 13 are to be inserted therein in order to produce a data-transmission connection to the interface of the transmitter 1.

FIG. 3 illustrates, in an embodiment of the invention, a further and particularly preferred option for data exchange between a transmitter 1 and a chip card 13 and an RMC chip card 9, specifically data exchange via RFID radio. For this purpose, the transmitter 1 has an RFID interface 21. The chip cards 9, 13 in FIG. 3 are RFID chip cards accordingly equipped with an RFID module 11 or 14, respectively. In such an embodiment of the invention, unidirectional or bidirectional data transmission can also be provided. Following a relevant initialisation process, the chip cards 9, 13 can be removed from the RFID radio range again. This also applies to the initialisation of the transmitter in normal operation by the TUC chip card 13. The transmitter 1 can then be used for the machine control until it is switched off.

1-16. (canceled)

17. A radio control system for controlling at least one machine, in particular a crane, comprising:
a radio receiver on the machine, which is assigned its own unique identification mark; and
a radio transmitter for generating and transmitting radiograms to the radio receiver;
wherein the radio transmitter is designed to generate and store identification data on the basis of information regarding the identification mark of the radio receiver,
wherein the radio transmitter is designed to include the identification data in its radiograms, it being possible to initialise the radio receiver in such a way that it accepts radiograms for the machine control when they contain relevant identification data in the radiograms,
wherein the radio transmitter is assigned its own unique identification mark,
wherein the radio transmitter is designed to generate the identification data on the basis of information regarding the identification mark of the radio transmitter and on the basis of information regarding the identification mark of the radio receiver,
wherein the radio control system further comprises a mobile data medium which is assigned to the radio receiver but can be transported separately therefrom and contains the information regarding the identification mark of the radio receiver as input data,
wherein the radio transmitter comprises an interface for transmitting data, to which interface the mobile data medium can be connected for data transmission and by means of which information regarding the identification mark of the radio receiver can be transmitted from the mobile data medium to the radio transmitter, the generation of the identification data on the basis of information regarding the identification mark of the radio transmitter and on the basis of information regarding the identification mark of the radio receiver requiring the process of reading out the information regarding the identification mark of the radio receiver.

18. The radio control system according to claim 17, wherein the identification data are system address data, by means of which the radio receiver can be addressed for receiving radiograms.

19. The radio system according to claim 17, wherein the mobile data medium assigned to the radio receiver is a chip card.

20. The radio control system according to claim 17, comprising at least one mobile badge data medium which is to be assigned or is assigned to the radio transmitter as an authorisation of use badge and can be transported separately therefrom, and in which authorisation of use data are or can be stored and which can be connected to the radio transmitter for data transmission, wherein the radio transmitter is designed to exchange data with the badge data medium that has been connected thereto for data transmission, to check authorisation of use data from the badge data medium, and, if the result of the check is positive, to allow the transmission operation thereof for radio control of the relevant machine, and so the radio transmitter can be enabled for the transmission operation by means of the badge data medium.

21. The radio control system according to claim 20, wherein the radio transmitter can be operated in an initialisation mode in which it can input the authorisation of use data into the badge data medium that has been connected thereto for data transmission.

22. The radio control system according to claim 21, wherein the badge data medium comprises an identification mark assigned thereto and has stored information regarding its identification mark and wherein, in the initialisation mode, the radio transmitter can read information regarding the identification mark of the badge data medium from the badge data medium that has been connected to the radio transmitter for data transmission and can generate the authorisation of use data for the badge data medium on the basis of the identification mark thereof.

23. The radio control system according to claim 20, wherein the badge data medium is a chip card.

24. The radio control system according to claim 20, wherein there is a plurality of badge data media, to which authorisation of use data are to be allocated in an appropriate initialisation mode, wherein it is possible for these authorisation data to be different and to contain information regarding limited authorisations of use which can be interpreted by the radio transmitter and implemented by the radio control system for limiting the machine control to certain modes of operation of the machine(s) to be controlled depending on the extent of the authorisation of use.

25. The radio control system according to claim 17, wherein said system comprises a plurality of radio transmitters, each of which has a unique identification mark, and wherein each radio receiver is assigned its own, yet separately transportable mobile data medium containing stored information regarding the identification mark of the relevant radio receiver, wherein it is possible to connect the relevant mobile data medium to the radio transmitter for data transmission in order to transmit the information regarding the identification mark of the relevant radio receiver to the radio transmitter, and wherein the radio transmitter is designed to generate and store identification data, which are to be assigned to the relevant radio receiver, on the basis of this information regarding the identification mark of said relevant radio receiver, and wherein the radio transmitter is also designed to include the identification data in its radiograms for the particular radio receiver, wherein each radio receiver can be initialised such that it only accepts radiograms for the machine control when they contain identification data assigned thereto in the radiograms.

26. The radio control system according to claim 17, wherein said system comprises a plurality of radio transmitters, each of which has an interface for inputting data, by means of which interface information regarding the identification mark of a particular radio receiver can be transmitted to the relevant radio transmitter, and wherein each radio transmitter is also designed to generate and store identification data, which are assigned to the relevant radio receiver, on the basis of this information regarding the identification mark of said receiver, and wherein each radio transmitter is also designed to include the identification data in its radiograms, wherein each radio receiver can be initialised such that it only accepts radiograms it has received for the machine control when they contain identification data assigned to said receiver.

27. The radio control system according to claim 26, wherein for each radio transmitter there is at least one separately transportable mobile badge data medium which is assigned or is to be assigned to the relevant radio transmitter as an authorisation of use badge, and in which authorisation of use data are or can be stored and which can be connected to the relevant radio transmitter for data transmission, wherein each radio transmitter is designed to exchange data with the badge data medium that has been connected thereto for data transmission, to check authorisation of use data from the badge data medium, and, if the result of the check is positive, to allow the transmission operation thereof for the radio control of the machine, and so the radio transmitters can be enabled for the transmission operation by means of the badge data medium.

28. The radio control system according to claim 27, wherein each radio transmitter can be operated in an initialisation mode in which it can input the relevant authorisation of use data into the badge data medium which has been connected thereto for data transmission.

29. The radio control system according to claim 27, wherein at least some of the badge data media can contain authorisation information which is assigned to particular modes of operation of the machine to be controlled, wherein the radio transmitters, when activated by such a badge data medium, are able to transmit the authorisation information, or data derived therefrom, in their radiograms, and wherein the radio receivers, upon receipt of such radiograms, are designed to only enable certain modes of operation of the machine, depending on the authorisation information or data derived therefrom.

30. The radio control system according to claim 17, wherein the radio transmitter is designed to pick up and log user data and/or data regarding their particular transmission operation.

31. The radio control system according to claim 30, wherein the radio transmitters are designed to store at least some of the user data and/or data regarding their particular transmission operation on the relevant badge data medium by which it has just been enabled for the transmission operation.
